(19) United States
(12) Patent Application Publication
(10) Pub. No.: US 2006/0055199 A1
(43) Pub. Date: Mar. 16, 2006

(54) Miniature sun visor apparatus and methods of use

(76) Inventor: Theodore Lerette, Cottonwood, AZ (US)

Correspondence Address: Raymond M. Galasso;Simon, Galasso & Frantz PLC, P.O. Box 26503, Austin, TX, 78755-0503, US

(21) Appl. No.: 10/941,246

(22) Filed: Sep. 15, 2004

(51) Int. Cl. B60J 3/00

(52) U.S. Cl. 296/97.9

(57) ABSTRACT

A sunlight obstruction apparatus for obstructing sunlight while driving a vehicle is described. In one form, a miniature sun visor for use with a vehicle includes a body having a front side, a rear side, an upper edge along a top portion and a lower edge along a bottom portion. A coupling mechanism may be positioned along the upper edge and/or lower edge to couple the sun visor to a vehicle. An aperture is also provided along a height of the body and approximately centered relative to a width of the body. The aperture is operable to fit around a rear view mirror of the vehicle.

### FIELD OF THE DISCLOSURE

The invention relates generally to an automobile apparatus, and more particularly to a miniature sun visor apparatus and method of use.

### BACKGROUND

Several hazards may be encountered when operating a vehicle including hazardous road conditions due to rain, ice, or snow. For example, rain mixed with oils on a road may create a slippery surface that may cause a driver to loose control when cornering a vehicle. Standing water may also cause complications when encountered by a vehicle causing the vehicle to hydroplane. Snow and ice also present a hazardous driving condition. For example, an icy surface may be difficult to detect but when encountered may cause a user to lose control of a vehicle. Black ice is common on any frozen surface in the wintertime and difficult to detect.

One type of hazardous condition that drivers may face on non-overcast days includes bright sunlight that may be incident on a user when operating a vehicle. For example, sunlight may vary in intensity and from various angles at different times of the day. Sunlight can temporarily blind a driver to making them momentarily disoriented. This may lead to a dangerous driving condition even though the overall environmental conditions or driving conditions are favorable.

Traditionally, a user may wear sunglasses to minimize incident sunlight. However, if a user does not have sunglasses available, a user may use a conventional sun visor to block the sunlight and partial vision of the driver. Such conventional sun visors extend along a portion of the windshield or door window and block the sunlight allowing a driver to operate a vehicle while facing the sun. However, depending on the angle of incidence, conventional sun visors may not extend enough to block sunlight while a driver is operating a vehicle. As such, what is needed is a sun visor apparatus that will allow for reducing incident light that traditional sun visors may not be able to obstruct thereby promoting safe driving on sunny days.

### BRIEF DESCRIPTION OF THE DRAWINGS

Other advantages, features and characteristics of the invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 illustrates a miniature sun visor according to one embodiment of the invention;

FIG. 2 illustrates an expanded view of a miniature sun visor association with a driver's side visor and a passenger's side visor of a vehicle according to one embodiment of the invention; and

FIG. 3 illustrates a miniature sun visor integrated as a part of a vehicle according to one embodiment of the invention.

### DETAILED DESCRIPTION OF THE FIGURES

A sunlight obstruction apparatus for obstructing sunlight while driving a vehicle is disclosed. In one form, a miniature sun visor for use with a vehicle includes a body having a front side, a rear side, an upper edge along a top portion and a lower edge along a bottom portion. A coupling mechanism may be positioned along the upper edge and/or lower edge to couple the sun visor to a vehicle. An aperture is also provided along a height of the body and approximately centered relative to a width of the body. The aperture is operable to fit around a rear view mirror of the vehicle.

In a particularized form, a miniature sun visor apparatus for use with a vehicle having a driver's side visor and a passenger's side visor is provided. The miniature sun visor includes an elongated body having made of a one or more light obstructing materials. The sun visor includes a coupling mechanism positioned along an upper portion of the elongated body and operable to couple the elongated body between the driver visor and the passenger visor. A mirror channel extends along a portion of a height of the elongated body and is operable to be placed around a mirror of the vehicle. In this manner, sunlight that may not be obstructed from the driver's side visor or the passenger's side visor may be reduced thereby promoting safe operation of a vehicle.

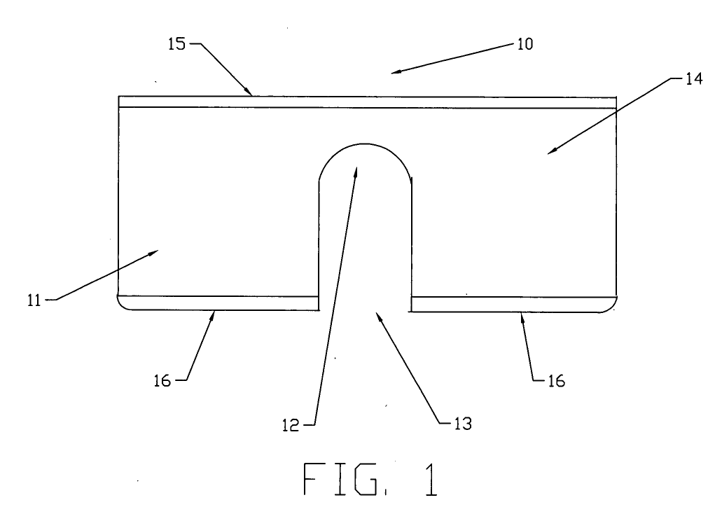

FIG. 1 illustrates a miniature sun visor according to one embodiment of the invention. A sunlight obstruction apparatus or sun visor 10 includes a body 11 made generally of one or more types of materials such as plastics, plexiglass material, transparent materials, opaque materials, solid materials, tinted materials, or any other type of material or combinations of materials that may be used to reduce transmission of light rays to a user of a vehicle (not expressly shown). Body 11 includes an aperture 13 or mirror channel sized to allow passage of a portion of a vehicle's mirror placing a mirror or mirror mount of a mirror on or about mirror receptacle 12 when mounted between a driver-side sun visor and a passenger side sun visor when present (not expressly shown). For example, some vehicles such as trucks may not benefit from having a rear view mirror due to the bed of the truck obstructing view of a rearview mirror. As such, sun visor 10 may be provided without aperture 13 or mirror receptacle 12.

Sun visor 10 further includes an upper edge 14 along an upper portion of body 11 provided in close proximity to a windshield of a vehicle (not expressly shown). Upper edge 14 includes an upper coupling mechanism 15 that may be used to couple sun visor 10 to a windshield of a vehicle. For example, a hook and loop material (i.e. Velcro®) may be used to couple sun visor 10 to an interior portion of a vehicle. One portion of hook and loop material may be mounted to upper edge 14 while a second portion of hook and loop material may be mounted to a vehicle's windshield. As such, sun visor 10 may be coupled to a portion of a windshield of a vehicle allowing for efficient mounting of sun visor 10. In other embodiments, a hook and loop material may be coupled to an interior portion of a vehicle to allow for placement of sun visor 10 during use. Other coupling mechanisms may also be considered that allow for efficient mounting and dismounting of sun visor 10. For example, one or more lower coupling mechanisms 16 may be provided instead of, in combination with upper coupling mechanism 15. One embodiment of lower coupling mechanisms 16 may include a hook and loop material provided along a lower portion of body 11 enabling sun visor 10 to be coupled to a portion of a rear view mirror (not expressly shown). In this manner, a user may couple sun visor using various combinations of coupling ensuring sun visor 10 is securely mounted.

During use, sun visor 10 allows for obstructing passage of sunlight that is missed through use of conventional sun visors such as a driver's or passenger's side sun visor. Sun visor 10 may be quickly and efficiently mounted by a user through sliding sun visor 10 around a rear view mirror if present (not expressly shown) using mirror channel 13 allowing for resting on or about mirror receptacle 12. A user may then align upper edge 14 with a portion of an interior of a vehicle to mount sun visor 10 using upper coupling mechanism 15 and/or lower coupling mechanism 16. In one embodiment, sun visor 10 may be made from a solid material that obstructs all incident light or may include a transparent or semi-transparent material having a tint to allows for passage of some light incident to sun visor 10. In this manner, a user may be able to see through sun visor 10 in a similar manner as sun glasses allowing for safe viewing.

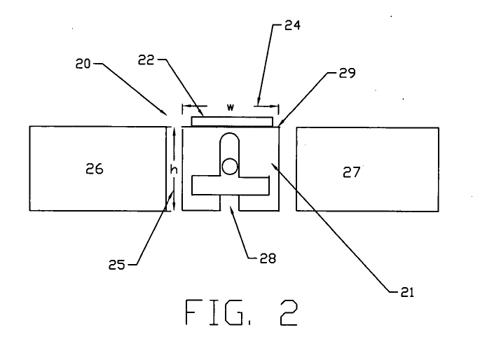

FIG. 2 illustrates an expanded view of a sun visor provided in association with a driver's side visor and a passenger's side visor of a vehicle according to one embodiment of the invention. A sun visor 20 includes an elongated body 21 coupled to a portion of a vehicle via coupling mechanism 22. Sun visor 20 is mounted between a driver's side visor 26 and a passenger's side visor 27 and proximal to a rear view mirror 28 of the vehicle. Sun visor 20 is sized smaller than driver's side visor 26 and/or passenger's side visor 27 and may be considered a miniature sun visor having a width 24 between six (6) inches and twelve (12) inches and a height 25 between three (3) inches and six (6) inches. For example, sun visor 20 may be sized smaller than driver's side visor 26 and passenger's side visor 27 as conventional visors are sized to extend along most, but not all, of an upper portion of a vehicles windshield (not expressly shown). As such, sun visor 20 may be combined with driver's side visor 26 and passenger's side visor 27 and as such may be provided in various sizes depending on the need of specific dimensions of a vehicle.

Sun visor 20 further includes coupling mechanism 22 that may be provided along a portion or all of an upper edge 29 of elongated body 21 to allow for mounting of sun visor 20 to a vehicle. Coupling mechanism 22 may include a hook and loop material as described above or other coupling mechanisms that may allow sun visor 20 to be a removable sun visor. For example, coupling mechanism 22 may be positioned along various portions of a vehicle's windshield allowing for reducing sunlight incident from various angles as needed.

During use, a user may mount sun visor 20 between driver's side visor 26 and passenger's side visor 27 through coupling sun visor 20 using coupling mechanism 22. For example, a first portion of a hook and loop material may be affixed to a vehicle's windshield while a second portion of a hook and loop material may be provided along upper edge 29. As such, a user may efficiently remove and replace mount sun visor 20 based on current driving conditions (i.e. daytime, nighttime, sunny, cloudy, etc.) as needed. Upon mounting sun visor 20, driver's side visor 26 and/or passenger's side visor may be independently used in combination with sun visor 20 depending on the angle or direction of the incident sunlight. A user may then remove and stow the sun visor as needed as driving conditions vary thereby allowing for efficient use of sun visor 20.

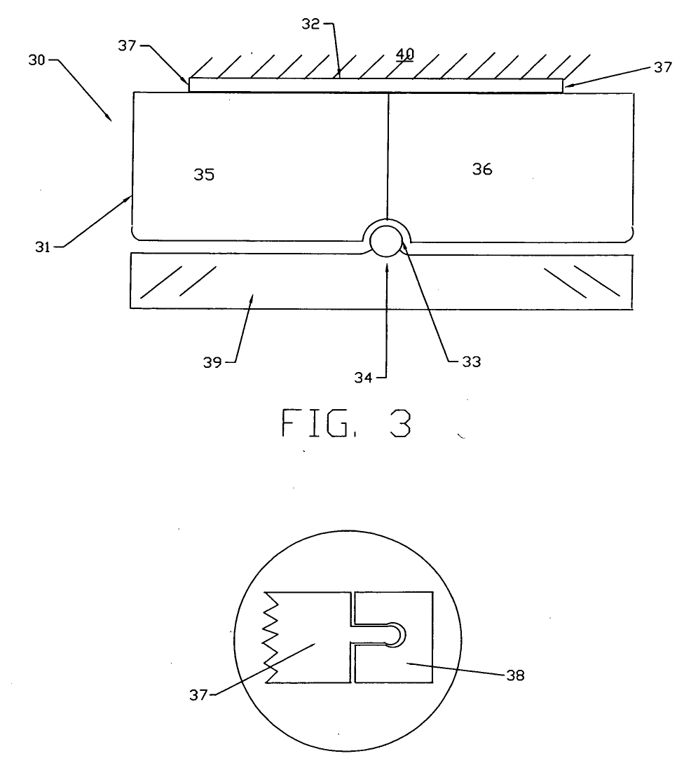

FIG. 3 illustrates a sun visor integrated as a part of an automobile according to one embodiment of the invention. A sun visor 30 includes a body 31 having a first half 35 and a second half 36. Sun visor 30 further includes a mirror channel 33 sized to fit around a portion of a mirror mount 34 of a vehicle. Sun visor 30 is coupled to a vehicle via coupling mechanism 32 that allows for rotational movement of sun visor 30. Coupling mechanism 32 may be provided in various ways and in one embodiment includes a plastic material having pins 37 sized to fit within a mounting recess 38 or cavity to allow mounting of sun visor 30. Coupling mechanism 32 may snap into place providing a secure mounting of sun visor 30 while allowing for upward and downward rotation as needed. Alternate coupling mechanisms such as hinges, spring loaded hinges, and the like may also be considered to mount sun visor 30.

Sun visor 30 is sized as a miniature sin visor and is operable to be mounted and used over a top portion of a rear view mirror 39 without contacting rear view mirror 39. Mirror channel 33 is sized to fit over mirror mount 34 and first half 35 and second half 35 are sized to be provided in close proximity to rear view mirror 39 without contacting mirror 39 during use. In this manner, rear view mirror 39 in combination with sun visor 30 may be used to inhibit sunlight from disorienting an operator of an vehicle thereby facilitating safe operation.

In one embodiment, body 31 having first half 35 and second half 36 may be divided into two sections that may be independently operated to inhibit incident sunlight. For example, coupling mechanism 32 may be configured to include two coupling mechanism for each of first half 35 and second half 36 that may be operated independent of each other. A user may rotate first half 35 and/or second half 36 independently as needed to obstruct incident. In this manner, a user may obstruct only a portion of a user's viewable area above mirror 39 allowing a user to maintain as much viewable area as needed.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

1-9. (canceled)

10. An sun visor apparatus for use with a vehicle having a driver visor and a passenger visor, the apparatus comprising:
an elongated body having a first half and a second half including a light obstructing material;
an upper coupling mechanism positioned along an upper portion of the elongated body and operable to couple the elongated body between the driver visor and the passenger visor, wherein a portion of the upper coupling mechanism is integrated as a part of an interior portion of the vehicle to mount the elongated body to the vehicle;
a lower coupling mechanism positioned along a lower portion of the elongated body and operable to couple the elongated body to the mirror mount of a the vehicle;
wherein the upper coupling mechanism and the lower coupling mechanism are operable to allow rotation of the first and second halves of the elongated body; and
a mirror channel extending along the lower a portion of the elongated body and operable to be placed around the mirror mount of the vehicle.

11. The apparatus as recited in claim 10 wherein the elongated body includes:
a width ranging between six and twelve inches; and
a height ranging between three and six inches.

12. The apparatus as recited in claim 10 wherein each coupling mechanism comprises a removable coupling mechanism operable to allow the elongated body to be removed and replaced from the vehicle.

13. (canceled)

14. The apparatus of claim 10 wherein the elongated body comprises a plastic material.

15. The apparatus of claim 10 wherein the elongated body comprises a tinted material.

16-20. (canceled)
